(19) United States
(12) Patent Application Publication
(10) Pub. No.: US 2016/0231288 A1
(43) Pub. Date: Aug. 11, 2016

(54) METHOD AND APPARATUS FOR MONITORING A DEVICE OF A DRIVE SYSTEM

(71) Applicant: WITTENSTEIN AG, Igersheim (DE)

(72) Inventor: Philippe Isabey, Weikersheim (DE)

(73) Assignee: WITTENSTEIN AG, Igersheim (DE)

(21) Appl. No.: 15/040,108

(22) Filed: Feb. 10, 2016

(30) Foreign Application Priority Data
Feb. 11, 2015 (DE) 10 2015 101 972.8

(51) Int. Cl. G01N 29/14; G08C 23/04

(52) U.S. Cl. CPC G01N 29/14; G08C 23/04

(57) ABSTRACT

A method and an apparatus for monitoring a device of a drive system are proposed. With the objective of improving the application range of monitoring the drive system, the beneficial solution provides for the device to comprise a rotatably arranged rotational element, and for a detector arranged on the rotational element to be provided for detecting structure-borne sound as a detection signal, wherein evaluating of the detection signal is performed by extracting a signal portion, which is not affected by sound impinged on the structure, from the detection signal, and by comparing it to a reference parameter. Based on the comparison, a determination is made whether a deterioration of the drive system is present.

### BACKGROUND OF THE INVENTION

The present invention relates to a method for monitoring a device of a drive system as well as an apparatus for monitoring a device of a drive system.

From the prior art, devices and methods are known by means of which conclusions should be drawn as to the wear or damaged condition of parts of a drive system. From US 2011/0142621 A1 a system is known in which components are subjected to an acoustical test by initially performing a sound application by means of a sound generator to a component to be tested. A sound signal measured by an associated sensor allows conclusions to be drawn about the component's mechanical condition.

### SUMMARY OF THE INVENTION

The invention is based on the task of proposing an improved method or an improved device for monitoring a device of a drive system, for example a motor or a gearbox. In particular the application range of the monitoring should be improved as compared to conventional solutions with the simplest possible means.

The task is solved by a method for monitoring a device of a drive system as well as an apparatus for monitoring a device of a drive system.

According to one aspect of the invention, a method is provided for monitoring a device of a drive system, wherein the device comprises a rotatably arranged rotational element having a detector disposed thereon for detecting structure-borne sound as a detection signal; including extracting an non-impinged signal portion from the detection signal; comparing the extracted signal portion to a reference parameter; and determining by means of the comparison whether a deterioration of the mechanical system is present.

According to a further aspect, the invention relates to an apparatus for monitoring a device of a drive system, wherein the device comprises a rotatably arranged rotational element, having a detector disposed on the rotational element for detecting passive structure-borne sound as a detection signal; and an evaluating unit for implementing one of the typical methods described herein, wherein the evaluating unit is in connection with the detector for signal transmission.

In typical methods, a non-impinged signal portion is extracted. With regard to the structure-borne sound signal, the method is typically provided as a passive method. Typically, an intentional or external impingement with sound, e.g. a test sound signal, of the device to be tested is not performed. The examined sound portion typically develops solely by the sound excitations of the devices to be monitored. In typical embodiments, the extracted signal portion develops solely due to the regular operation of the drive system's device.

Typical embodiments offer the advantage that active sound application is not of compelling necessity. Typical embodiments offer the advantage that the method for monitoring a device of a drive system can be performed during the operation of the drive system's device. Typical embodiments do not comprise a sound application means.

When extracting, the detection signal is typically restricted to at least one previously defined frequency range. For this purpose, the extraction, for example may include a filtering, optionally a band pass filtering or average filtering, which restricts the detection signal to one frequency range. In embodiments, an integral transformation into the frequency range is possible, whereupon a selection of the frequencies of interest is performed. In further typical methods, a plurality, e.g. two or three or more, non-contiguous sub-frequency ranges within a larger frequency range are extracted for the evaluating. Hereby, frequencies may remain unconsidered in the evaluating, for example, which are associated to a parameter of no interest, e.g. a disturbance variable.

Since the detection signals are structure-borne sound signals, according to one aspect of the invention, the previously defined frequency range which is subdivided, as need be, into non-contiguous sub-frequency ranges, has a lower limit of 20 kHz. As an alternative or in addition, the previously defined frequency range has an upper limit of 2 MHz. Preferably the previously defined frequency range has a lower limit of 50 kHz or 100 kHz. As an alternative or in addition, the previously defined frequency range preferably has an upper limit of 1 MHz or 300 kHz.

According to one aspect, a decimation of the data, e.g. by forming an effective value of the detection signal or a statistic method, e.g. determining the kurtosis, is provided in the course of comparing the extracted signal portion to a reference parameter. In one case, each emission signal situated within the frequency range to be examined and exceeding a determined threshold value is considered to be a so-called sound event. Such sound events are relatively steep-edged and may be recognized in the examined frequency spectrum as frequency-selective peaks, i.e. as signal levels distinctly exceeding the levels of the frequencies that are contiguous at the examined time or in the examined time interval. Within the time range, if appropriate also in the time range following a previously performed frequency-dependent filtering, such sound events may also exhibit time-selective peaks, i.e. as sound levels distinctly exceeding the level at the times or time intervals that are contiguous as seen in the course of time.

For examining the signal, the signal may be divided into time intervals. Typically, an examined time interval is at least as long as a sound event, for example at least 1 s or at least 500 ms or at least 100 ms. Typically, the duration of the sound event is that time during which the signal's envelope is greater than a predetermined threshold value. Typically, the examination is continuously repeated. Typically, after completing an examination of the extracted signal portion in one time interval, further examinations of the extracted signal portion are carried out in subsequent time intervals. The respective examined time intervals may be of equal or different lengths.

In embodiments, the extracted signal is examined in the examined time interval for the presence of frequency-selective peaks. In embodiments, the extracted signal is examined in the examined time interval for the presence of time-selective peaks.

A frequency-selective peak typically exceeds the levels distinctly in the range of at least ±50% or at least ±30% or at least ±10% of the peak frequency. In case of a distinct excess, the amplitude of the frequency-selective peak is typically by about at least 50% or by at least 30% or by at least 10% higher than the amplitude of the further frequency portions.

Typically, a time-selective peak exceeds distinctly the levels of at least ±50% or of at least ±30% or of at least ±10% of the averaged levels of the examined time interval. In case of a distinct excess, the amplitude of the time-selective peak is typically by at least 50% or by at least 30% or by at least 10% higher than the amplitude of the level in the further signal pattern of the examined time interval. In embodiments, the amplitude of the time-selective peak, in case of a distinct excess, typically is by at least 50% or by at least 30% or by at least 10% higher than the amplitude of the averaged level of at least two examined time intervals.

Typically, a sound event is steep-edged when the rising edge or falling edge of the extracted sound signal satisfies the following inequation:

$$Δ t \leq \frac{C}{B}$$

Δt designates the chronological interval of the rising edge or the falling edge. B designates the bandwidth of the exciting signal and/or the bandwidth of the transmission medium, e.g. the transmission path. C is a constant and is typically selected as a value of between 0.2 and 0.5. In typical embodiments, C=0.35. If the bandwidth B of the exciting signal and the transmission path is 100 kHz, for example, then the sound event is steep-edged, when the rising edge or the falling edge of the extracted sound signal is within a time interval of 3.5 μs or less.

In embodiments, a sound event is steep-edged, when the rising or falling edge of the extracted sound signal exhibits a rising time or a falling time of at most 50 μs or at most 5 μs or at most 0.5 μs. In embodiments, the edge steepness of an overshooting of the extracted sound signal in a positive signal direction or a negative signal direction is examined in the extracted sound signal.

The sound events are counted according to one aspect. In typical embodiments, the sound events are counted in fixed time intervals. In typical embodiments, the length of the fixed time intervals may be unchanged during the operation. In typical embodiments, the length of the fixed time intervals may be variable during the operation, for example may be variable according to previously defined or definable examining patterns. A previously defined or definable examining pattern, for instance may exhibit a periodic or non-periodic sequence of various fixed time intervals. A sequence, for instance may exhibit one or more time intervals of a duration of at least 1 s, or one or more time intervals of a duration of at least 100 ms. In a continuous evaluation, a chronological averaging of the detection signal is typically performed. In typical embodiments, a summation of the events per evaluated time unit is performed which corresponds e.g. to the detector's sampling rate or e.g. a rate generated by a timer. Evaluating the chronological development of these totalized events typically allows conclusions to be drawn about the actual condition of the drive system's monitored device, from which a prognosis of the failures of the drive system, respectively the drive system's device can be given.

According to one aspect, a parameter based on the signal portion, i.e. a parameter derived or derivable from the non-impinged signal portion extracted from the detection signal is referenced to its chronological course. The parameter based on the signal portion may be the signal portion itself. Typically, the slope of the parameter based on the signal portion is determined for different time intervals. Different time intervals are time intervals starting or ending at different times in the course of time. The different time intervals may be of equal duration. The different time intervals may also be of different or partially different duration.

Typically, the slopes, i.e. the slopes respectively determined for one time interval during the different time intervals, are compared. The comparison can be used for determining whether a deterioration of the mechanical system is present.

In typical embodiments, the time intervals are derived from the detector's sampling frequency. Typically, the time intervals correspond to the detector's sampling frequency. Alternatively, the clock for the time intervals is generated, e.g. by an external timer or another timer present anyway, without relation to the detector's sampling frequency.

In typical embodiments, the signal portion in the time intervals is summed up and the sum is related to the chronological course. In embodiments, this is the sum of the counted sound events which is related to its chronological course.

In typical embodiments, the slope of the parameter based on the signal portion is determined. In this case, the term “slope” is to be interpreted technically. Thus, the slope is not necessarily determined in the strictly mathematical sense; in case of a time-discrete parameter based on the signal portion, this slope may rather be determined approximately by establishing the difference of the parameter at contiguous sampling times.

The chronological course of this slope, for example a “kink”, allows a determination to be made in the comparison whether a deterioration of the drive system's device or other components of the drive system is present.

In typical embodiments, the detector is arranged on a structural member of the drive system. Drive-related forces and/or moments may act upon this structural member. This can ensure precise monitoring. Examples of a drive system are a motor or a gearbox. Further types of drive systems or subtypes of the examples cited above may be provided. For example, a motor as one example of a drive system may be configured as an electric motor, e.g. as a synchronous motor or as an asynchronous motor or as a servomotor. The motor may even be configured as a non-electrically driven motor such as a hydraulically driven motor, as a radial piston motor or axial piston motor. The gearbox as one example of a drive system may be configured for instance as a linear gear or as a planetary gear or as a chain gear or else as a hydrostatic or hydrodynamic gear. Examples of a drive system are also combinations of a motor, for example one of the motor types cited above, and a gear, for example one of the gear types cited above, e.g. a rack and pinion drive.

The evaluating unit in typical embodiments is designed to execute typical methods described herein, inter alia to extract a non-impinged signal portion from the detection signal, to compare the extracted signal portion to a reference parameter and to determine by means of the comparison whether a deterioration of the drive is present.

According to a further aspect, a wireless transmitting means is provided for the communication between the detector and the evaluating unit. This wireless transmitting means is typically arranged on the rotational element and serves the purpose of transmitting a transmission signal based on the detection signal. A stationary wireless receiving means serving the purpose of receiving the transmission signal from the wireless transmitting means is in turn connected to the evaluating unit.

The transmission signal based on the detection signal is in embodiments the detection signal itself. In further embodiments, parts of the methods described herein are already performed on the side of the rotational element, for instance in the form of signal pre-processing. In embodiments, these parts may for instance comprise the extracting of the non-impinged signal portion from the detection signal. By way of example, a discretization or modulation or filtration realized on the side of the rotational element may result in that any signal noise that is possibly present will not increase during the transmission. The signal-to-noise-ratio may typically be improved when the discretization or modulation or filtration ensues already on the side of the rotational element, for example.

In embodiments, the more complex part of the method described above, thus, in particular, the comparing or determining, is carried out in the evaluating unit. The stationary evaluating unit is typically appropriate to accommodate the complex, for example computationally and energetically intensive or space-consuming components therein, whereas the detector which is able to detect the detection signal directly at the rotational element may typically have the components required for this purpose. This may reduce the apparatus's susceptibility to errors and may reduce possible undesired effects on the drive system.

The wireless transmission of the detection signal from the rotational element to the stationary evaluating unit enables a simple transmission of the data, with only few components to be accommodated being required to be employed in the rotational element at the same time. Typical embodiments are cost-efficient. Good flexibility is typically achieved in selecting the place in the signal chain where the wireless transmission takes place.

In embodiments, the evaluating unit is designed to determine by the comparison whether or not a damage or deterioration of the mechanical system is present with regard to the reference parameter.

In other words: The evaluating unit in embodiments evaluates the current condition of the drive system's monitored device by means of the comparison. On this basis, also a failure prognosis of the device may be given which—in contrast to known procedures such as e.g. the damage accumulation method—typically does not disregard the device's real actual condition.

In embodiments, the wireless transmission means exhibits an optical transmitter. In embodiments, the wireless receiving means exhibits an optical receiver. Optical signal transmission may enable a large transmission bandwidth for the useful signal. Typically, the noise ratio is large in optical signal transmission.

In embodiments, the rotational element is a gearwheel, optionally a pinion. Typically, the drive system's device is a rack-and-pinion drive.

When a pinion is used, the same cooperates mechanically with at least one toothed rack, i.e. the mechanical system formed by the pinion and rack is evaluated by the evaluation performed by means of the evaluating unit. Conventional solutions often provide for a plurality of sensors on the stationary elements of a drive system, thus on the rack, respectively racks. In embodiments in the present case according to the described aspect, only a single sensor is needed in the rotational element to monitor the drive system's device.

In embodiments, the detector exhibits a sensor of structure-borne sound fixedly coupled to the rotational element for receiving a structure-borne sound signal. The transmission of the structure-borne sound into the sensor of structure-borne sound essentially takes place directly and without essential attenuation. Typically, detection at high sensitivity and low noise component is possible. Typically, the evaluating accuracy is improved.

In embodiments, the detector exhibits a signal processing circuit for processing the received structure-borne sound signal. By means of a signal processing occurring here, the detection signal may be conditioned—for example pre-filtered—in advance. It may be adapted to the specific issues of wireless transmission, for instance by a modulation process or the like. In embodiments, a part of the evaluating unit is integrated in the signal processing circuit. With respect to a possible failure susceptibility of the wireless transmission path, the data of the detection signal may be filtered, amplified and/or decimated in the integrated part of the evaluating circuit.

In embodiments, the evaluating unit exhibits a stationary transmitter for transmitting energy in a wireless manner. On the rotational element, a receiver is provided which is connected to the detector, receives the energy from the stationary transmitter on a wireless path and typically supplies the detector with electrical energy.

In other words: In embodiments, an energy transmission device is provided, whose transmitter is stationary and supplied with energy, and whose receiver is arranged on the rotational element and supplies the detector with energy. Similar to the transmission of the useful signal from the rotational element to the stationary evaluating unit, the energy supply of the detector and/or adjacent and likewise rotating parts typically ensues in a wireless manner.

When the wireless transmission is performed via an optical connection as cited above, an inductive transmission path is appropriate for the energy transmission. This transmission path scarcely influences the optical transmission path in terms of its noise ratio, but enables an efficient energy transfer. The detector does not need its own integrated energy supply, for instance in the form of a battery or the like.

In the case of an optional uninterruptedly continuous, i.e. permanent energy supply of the detector, the signal output of the detector itself may be operated to be continuous (i.e. continuous in a time-continuous or time-discrete manner). Typically, a continuous evaluation of the detection signal may be performed in the evaluating unit. Typically, a storing of the energy and/or the evaluation result and/or the observation interval is performed.

### BRIEF DESCRIPTION OF THE DRAWINGS

Further advantages and features of preferred embodiments of the invention will be explained below by means of the accompanying drawings.

Shown are in the drawings:

FIG. 1: a schematic lateral sectional view of a beneficial apparatus according to an embodiment of the invention;

FIG. 2: a schematic view of a rack and pinion arrangement in which the apparatus according to the embodiment is employed; and

FIG. 3: an exemplary diagram of evaluated sensor measurement data for explaining the beneficial apparatus and the beneficial method according to the embodiment.

### DETAILED DESCRIPTION

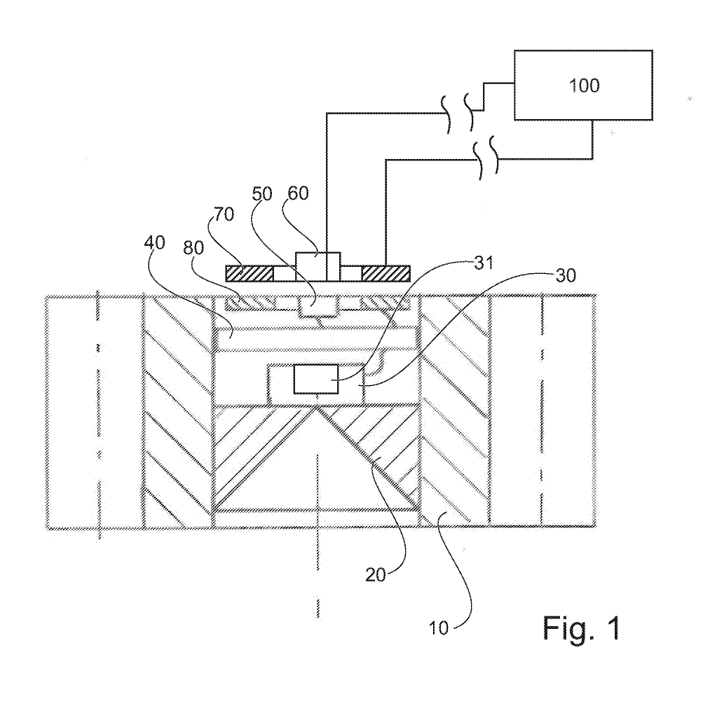

FIG. 1 shows a schematic lateral sectional view of a beneficial apparatus according to an embodiment of the invention.

In FIG. 1, a part of a device to be monitored of a drive system is shown, in the exemplary embodiment of FIG. 1 this is a rotational element 10 in the form of a pinion which, when in operation, is in engagement with a rack (not illustrated in FIG. 1).

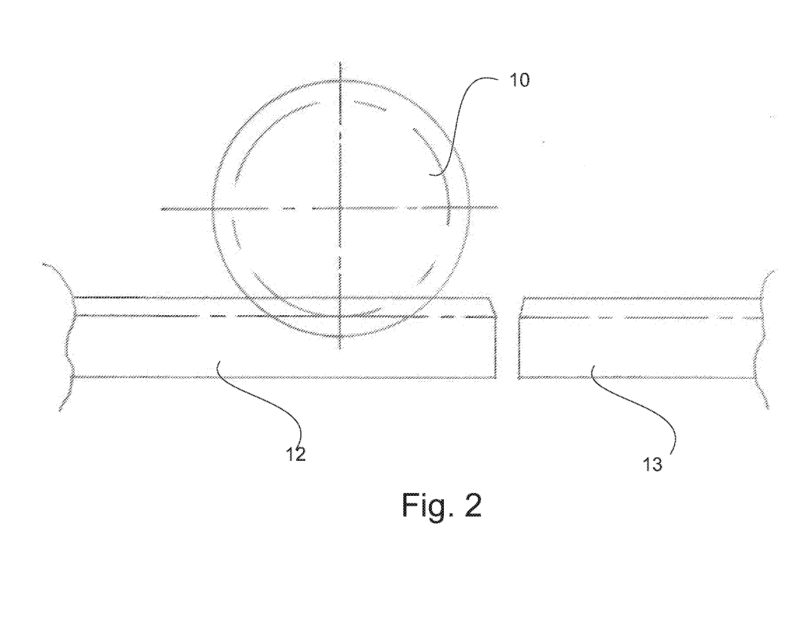

As can be seen in more detail from the representation in FIG. 2, the pinion as the rotational element 10 is in operative connection with a rack arrangement of a first rack 12 and a thereto contiguous second rack 13.

Again with reference to FIG. 1 may be recognized that the rotational element 10 is arranged rotatably with respect to an evaluating unit 100 described below, and a wireless receiving means 60 likewise described below, as well as, if need be, with respect to further stationary elements which are not illustrated. In this case, “stationary” is to be understood as a relative reference to the rotational element 10, i.e. the respective stationary element may be—e.g. with regard to a device accommodating the drive system—quite mobile relative to same.

In a detector seat 20 within the rotational element 10, a detector 30 is accommodated which is configured to detect a structure-borne sound signal and to supply the same as a signal parameter in the form of a detection signal to a signal processing circuit 40 which is likewise arranged in the rotational element 10. The detector 30 is mechanically fixed to the rotational element 10 by means of the detector seat 20 so that the rotational element 10 allows a structure-borne sound signal, i.e. a sound signal propagating in the rotational element 10, to be detected directly.

The detector 30 exhibits a sensor 31 of structure-borne sound fixedly coupled to the rotational element for receiving a structure-borne sound signal. In the embodiment shown in FIG. 1, the evaluating unit exhibits a stationary transmitter 70 for transmitting energy in a wireless manner. On the rotational element, a receiver 80 is provided which is connected to the detector, receives the energy from the stationary transmitter on a wireless path and supplies the detector with electrical energy.

The structure-borne sound signals of interest (Acoustic Emission, “AE”) exhibit an essentially pulse-shaped excitation progress and arise when in a mechanical system—thus e.g. in the drive system—events occur that entail a deterioration of the system's condition such as, for example crack formation prior to a fatigue failure. This also enables a precise monitoring of the drive system's device to be achieved by means of the beneficial apparatus, respectively the beneficial method in case of error causes which are otherwise difficult to detect, for instance in the case of insufficient lubrication between a pinion and a rack or when harsh dusts arise which develop for example in laser processing machines.

The exemplary embodiment as per FIG. 1 shows: After pre-filtering and smoothing of the detection signal are completed in the signal processing circuit 40, the detection signal will now be evaluated. The transmission signal thus derived from the detection signal is provided to be transmitted by means of a wireless transmitting means 50 to the wireless receiving means 60 cited above and disposed on the stationary side. The wireless receiving means 60 is stationary relative to the rotational element 10. The wireless receiving means 60 in turn supplies the transmission signal to the evaluating unit 100 cited above in a wired or wireless manner.

The evaluating unit 100 now evaluates the signal thus transmitted thereto, by extracting a signal portion from it and comparing it to a reference parameter.

However, the extraction—e.g. a filtering—may have been done already to a large extent by the signal processing circuit 40. A signal portion is examined which is characteristic for the system and its possible types of deterioration. For example, a certain previously defined frequency range within that range is examined in which the structure-borne sound signal is able to propagate. A possible, previously defined frequency range has in this case a lower limit of 20 kHz or 50 kHz or 100 kHz. As an alternative or in addition, it has an upper limit of 300 kHz or 1 MHz or 2 MHz.

With respect to the detector's nature, (analog) detectors operating in a time-continuous and value-continuous manner, (digital) detectors operating in a time-discrete and quantized manner, etc. are possible, for example.

The evaluating unit 100 samples the detection signal supplied to it and decimates the data after the extraction by means of a statistic method. In the present case, the sound events are counted, summed up and assigned to the cycle number of the respective time of the evaluation. Sound events are every excess of a (possibly frequency-dependent) previously defined amplitude threshold value of the detection signal.

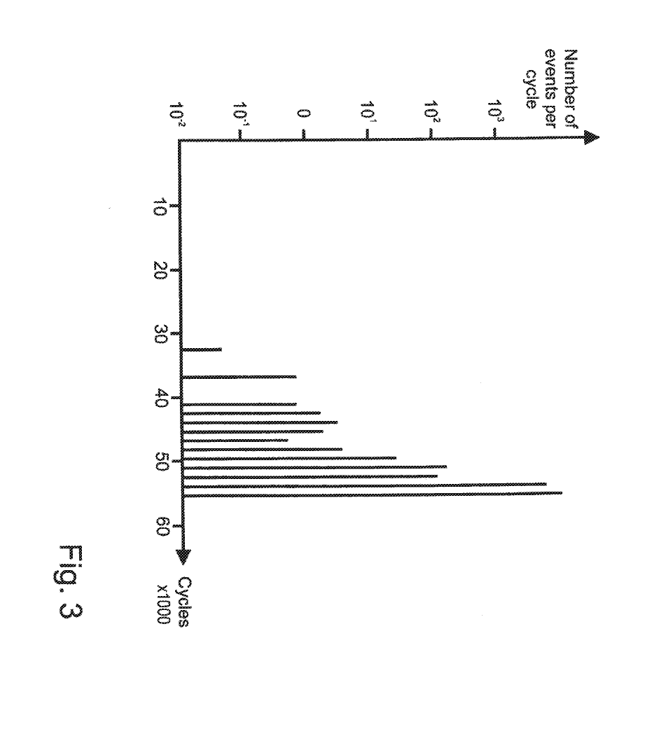

In the exemplary diagram in FIG. 3, an evaluation diagram is shown which results in such a manner. Once a cycle number of 50,000 cycles is exceeded, the number of sound events per cycle is increasing distinctly in the shown example. The evaluating unit 100 derives a prognosis for a probable failure time from the event history.

In the present embodiment, the slope of this signal progress is evaluated at each examined time interval. Since time-discrete values are examined, an approximation of the slope is performed by establishing the difference of chronologically contiguous signal values.

Once a characteristic “kink” is identified in the progress of the thus obtained slope curve, i.e. for example a characteristic increase of this slope, a significant deterioration of the drive system may be concluded, for example. A characteristic “kink” may be interpreted as a range of the curve in which the slope, even at reasonable approximation, is not linear, the signal progress therefore increases in a non-linear manner. The “kink” must not necessarily be non-differentiable. The presence of a monotonously increasing function of the signal, the slope of which exceeds a defined or definable threshold value, may for example be sufficient for the presence of a characteristic “kink”. The threshold value, from which such a “kink” can be expected, is for example a change of the slope by more than 25% in an observation period of typically several hours. The chronological position of the “kink” is typically independent, respectively robust in terms of the signal amplitude's height.

The threshold values may have been determined empirically. The detector 30 is disposed in the rotational element 10. A conclusion may also be drawn about the probable time of failure of other elements. These other elements are different from the rotational element 10.

The rotational element 10 is coupled with the rack 12, respectively 13. The detector is disposed in the rotational element 10. Monitoring, e.g. lifetime monitoring, not only of single components of the drive system but also of several drive system elements is possible, namely by means of only one detector 30.

1. A method for monitoring a device of a drive system, wherein the device has a rotatably arranged rotational element having a detector arranged thereon for detecting structure-borne sound as a detection signal, including the steps of:
extracting a non-impinged signal portion from the detection signal;
comparing the extracted signal portion to a reference parameter; and
determining on the basis of the comparison, whether a deterioration of the mechanical system is present.

2. The method according to claim 1, further comprising:
restricting the detection signal to at least one previously defined frequency range.

3. The method according to claim 1, further comprising:
restricting the detection signal to a frequency range having a lower limit of 20 kHz and/or having an upper limit of 2 MHz.

4. The method according to claim 1, the method further comprising the following:
counting the signal portion's exceeds beyond a previously defined threshold value.

5. The method according to claim 1, further including:
referencing a parameter based on the signal portion to the parameter's chronological development; and
determining in each case the slope of the parameter based on the signal portion for different time intervals; and
comparing the slopes for determining whether a deterioration of the mechanical system is present.

6. An apparatus for monitoring a device of a drive system, wherein the device comprises a rotatably arranged rotational element, including:
a detector arranged on the rotational element for detecting passive structure-borne sound as a detection signal; and
an evaluating unit for implementing the method according to claim 1, wherein the evaluating unit is in connection with the detector for signal transmission.

7. The apparatus according to claim 6, comprising:
a wireless transmitting means disposed on the rotational element for transmitting a transmission signal based on the detection signal; and
a stationary wireless receiving means in connection with the evaluating unit for receiving the transmission signal from the wireless transmitting means.

8. The apparatus according to claim 7, wherein the wireless transmitting means comprises an optical transmitter, and wherein the wireless receiving means comprises an optical receiver.

9. The apparatus according to claim 6, wherein the detector comprises a sensor of structure-borne sound fixedly coupled to the rotational element for receiving a structure-borne sound signal.

10. The apparatus according to claim 6, wherein the detector comprises a signal processing circuit for processing the received structure-borne sound signal.

11. The apparatus according to claim 6, comprising:
a stationary transmitter for the wireless transmission of energy; and
a receiver disposed on the rotational element, which is in connection with the detector, for receiving the energy from the stationary transmitter and for supplying at least the detector with electrical energy.
